(19) United States
(12) Patent Application Publication
(10) Pub. No.: US 2014/0166815 A1
(43) Pub. Date: Jun. 19, 2014

(54) TETHER FOR SPACECRAFT REACTION CONTROL SYSTEM

(71) Applicant: ARTHUR M. DULA, Houston, TX (US)

(72) Inventor: ARTHUR M. DULA, Houston, TX (US)

(21) Appl. No.: 14/025,822

(22) Filed: Sep. 13, 2013

Related U.S. Application Data
(63) Continuation-in-part of application No. PCT/US2012/028841, filed on Mar. 12, 2012.
(60) Provisional application No. 61/801,092, filed on Mar. 15, 2013.

(51) Int. Cl. B64G 1/24

(52) U.S. Cl. CPC B64G 1/24
USPC 244/164

(57) ABSTRACT

A spacecraft reaction control system comprising: a spacecraft having a center of mass; a length of tether extending from said spacecraft and offset from said spacecraft's center of mass and means for controllably changing said extension of said offset such that a variable force is exerted upon said spacecraft by said tether, said force being offset from said center of mass.

This application claims the benefit of Patent Cooperation Treaty application number US2012/028841 and U.S. provisional application No. 61/801,092 which are both hereby incorporated by reference.

### FIELD OF THE INVENTION

The present invention pertains generally to returnable spacecraft and space vehicles. The term “returnable” refers to the ability of spacecraft to leave and later reenter planetary atmosphere and reach the planet's surface intact. More specifically, the invention pertains to reaction control systems and methods of use for returnable space vehicles re-entering planetary atmosphere.

### BACKGROUND

Atmospheric re-entry refers to the process by which vehicles outside of a planet's atmosphere can enter or reenter the atmosphere and reach the surface of the planet intact. The technology for atmospheric re-entry owes its origins to the development of intercontinental ballistic missiles (ICBMs) during the Cold War. Basic calculations showed that the kinetic energy of a nuclear warhead returning from orbit was sufficient to completely vaporize the warhead. In order to prevent a spacecraft from suffering a similar fate, several obstacles had to be overcome.

There are difficulties that are inherent aspects of atmospheric entry caused by high velocity transit through an atmosphere. These problems include high temperatures generated by friction between the entry system and the atmosphere while the atmospheric entry system is traveling through the atmosphere at high velocities, high acceleration loads experienced by the reentry system and its payload due to rapid changes in the system's velocity, and difficulty of controlling the flight path as the system descends through an atmosphere due to causes including poor aerodynamics, high velocities, and the requirement of fast reacting guidance methods. Each of these problems can be mitigated by allowing the atmospheric transit to occur over a longer period of time to allow for better flight control and less extreme aeroheating.

The transportation of a space object through an atmosphere is not necessarily difficult. All that must occur is that the gravitational attraction between the object in space and the celestial body overcome the other forces acting on the object. This results in a ballistic entry into and through the atmosphere of the celestial body, followed by the object reaching the surface of the celestial body. However, entering and traversing an atmosphere ballistically is relatively uncontrolled and can be physically damaging to the object entering the atmosphere, its payload, or to the celestial body.

The energy put into a spacecraft by the launch system, usually a powerful rocket, must be removed from the spacecraft before it can land without damage. The spacecraft starts at zero altitude and zero velocity. It is then accelerated to a high velocity by the launch system. For example, the velocity required to keep a spacecraft in low Earth orbit is about 18,000 miles per hour while a spacecraft on a direct return from the Moon will have a reentry velocity of about 25,000 miles per hour. The kinetic energy (Eₖ) of the returning spacecraft is equal to half the mass (m) of the spacecraft multiplied by the square of the spacecraft's velocity (v), expressed as Eₖ=½mv². The potential energy (E_{P}) of a returning spacecraft is its altitude (h) multiplied by its mass (m) and a gravitational constant (g), expressed as E_{P}=mgh. Most of a spacecraft's kinetic energy must be removed during reentry by aerodynamic drag between the spacecraft and the atmosphere for the spacecraft to land safely. This is why reentering spacecraft must have effective thermal protection systems, “heat shields,” and even with effective thermal protection the temperature on the aerodynamic surface of the spacecraft can rise to thousands of degrees because all of the kinetic energy of the spacecraft's velocity is removed in only a few minutes of flight. This heating causes the plasma “fireball” that surrounds a reentering spacecraft.

Deceleration is one obstacle in atmospheric re-entry. The Earth's rotational velocity is approximately 100 miles per hour at the equator, and slightly slower at the higher latitudes. When a spacecraft leaves Earth orbit and prepares for re-entry, it can be traveling as fast as 18,000 mph. From the time of re-entry to just before landing, the spacecraft must decelerate to match the Earth's rotational velocity as closely as possible. Deceleration is generally accomplished by relying on atmospheric friction and drag (i.e. using wind resistance), a technique known as aerobraking. Aerobraking, however, presents another obstacle. The air in the Earth's atmosphere is composed mostly of nitrogen and oxygen. When an object such as a spacecraft moves through the atmosphere at supersonic speeds, it generates shockwaves as it collides with particles in the atmosphere. Since the orbital velocity for most spacecraft is several times the speed of sound, air molecules in the path of the spacecraft are “shock heated”, or compressed so violently that the temperature of the shockwaves increases to thousands of degrees. To

provide an example, meteorites entering the Earth's atmosphere are often vaporized by their own shock waves. Because of shock heating, re-entry space vehicles require a heatshield of some form, usually comprising highly effective insulators.

Additionally, a spacecraft's speed and the resulting collisions with molecules in the atmosphere break up neutral atoms and molecules into electrons and ions. In high speed flows, shock heating and viscous dissipation in the boundary layers will first lead to a dissociation of the participating molecules (breaking the molecules into their individual atoms). At higher temperatures the collisions are so violent that the electrons are knocked clear of the nucleus. These free electrons and ions form plasma. Re-entry vehicles all generate plasmas due to shock and boundary layer heating, Radio waves cannot penetrate the highly conductive plasma, and therefore, re-entry vehicles suffer from a temporary radio blackout during re-entries.

Resulting heat from collisions with molecules in the atmosphere makes it imperative for a spacecraft's re-entry “angle of attack,” relative to the atmosphere, to fall within a certain range. The angle of attack must be oriented so that the heatshield absorbs the bulk of the re-entry heat. If the angle of attack is too shallow, the

spacecraft will skip off the atmosphere and back towards space (similar to a stone being skipped across the surface of a lake. If the spacecraft's angle of attack is too steep, the spacecraft risks burning up due to extremely high heat loads from excess friction with air molecules. The window of a successful angle of attack depends on the spacecraft's geometry, speed, and surrounding air density. Air is less dense in the upper atmosphere, and thus, a spacecraft will encounter less friction. By approaching the Earth at a shallow angle, the spacecraft can spend more time in the upper atmosphere and increase the duration of deceleration. As the spacecraft moves lower into the atmosphere, it may have to adjust its angle of attack by means of a reaction control system, a mechanism for attitude control.

A reaction control system (RCS) is a subsystem of a spacecraft that is used for reentry flight dynamics. Its purpose is for attitude control and steering. Attitude control refers to control of the angular position or rotation of the spacecraft relative to the object it is orbiting. These angles are referred to as pitch, yaw and roll. An RCS system is capable of providing small amounts of thrust in a desired direction or combination of directions. An RCS system is also capable of providing torque to allow control of rotation. This is in contrast to a spacecraft's main engine, which is only capable of providing thrust in one direction, but is much more powerful. RCS systems can be used not only for attitude control during re-entry, but also for station keeping in orbit, close maneuvering during docking procedures, control of orientation, and as a backup means of de-orbiting.

On Apr. 12, 1961, the Soviet space program launched Vostok I, the first manned space flight. Although the service module of Vostok I had a nitrogen gas RCS system, the re-entry capsule lacked an RCS system and was unable to perform attitude control in flight. Hence, the Vostok I re-entry capsule was designed as a sphere with a heat-shield covering the entire outer surface of the capsule.

U.S. Pat. No. 3,093,346, by Faget, discloses a space re-entry capsule with attitude control via means of generating torque thrusts. The '346 patent was the design for the space capsules for Project Mercury, the first United States manned flight space program. The Mercury capsules were equipped with hydrogen peroxide (H₂0₂) RCS systems providing thrust for attitude control.

Over the years, RCS systems have improved, but generally maintain the same operating concepts. Conventional RCS systems are limited by the amount of fuel the spacecraft can carry. If the fuel is completely exhausted before reentry is achieved, the spacecraft will lose its ability for attitude control.

Beginning with the United States Gemini Program, the current standard for fuel on many RCS systems has been a hi-propellant hypergolic liquid combination of an oxidizer and hydrazine or a hydrazine derivative. One example is monomethyl hydrazine (CH₃N₂H₃) with nitrogen tetroxide (N₂0₄) as an oxidizer. As a hypergolic combination, the constituents ignite on contact with each other and create the thrust force for the RCS system. The disadvantages are that hydrazine, hydrazine derivatives, and nitrogen tetraoxide (N₂0₄) are generally very expensive and toxic to humans. Orion Propulsion, Inc. has developed an oxygen and methane RCS thruster for use on spacecraft. However, the inventor is not aware of an RCS system that uses oxygen or a mixture of oxygen and other gases (i.e. nitrogen) breathable by humans having the further feature of serving as part of a secondary life support system.

Because spacecraft can only carry a finite amount of fuel with little chance to refill, some alternative RCS systems have been developed so that fuel can be conserved. One such alternative RCS system used momentum wheels which spin to control rotational rates on a vehicle. U.S. Pat. Nos. 6,834,561, 6,463,365, and 5,386,738 describe a control moment gyroscope (“CMG”) for spacecraft attitude control consisting of a spinning rotor and one or more motorized gimbals that tilt the rotor's angular momentum. As the rotor tilts, the changing angular momentum causes a gyroscopic torque that rotates the spacecraft.

A tether is a long cable usually made of thin strands of high-strength fibers and/or conducting wires. It is known in the art to use tethers to decelerate and deorbit an object in orbit around a celestial body. The inventor is not aware of any publication describing the use of a tether for spacecraft attitude control.

The NASA Hypersonic Inflatable Heat Shield Prototype which was tested suborbitally on Jul. 23, 2012 is an example of an inflatable reentry system. This inflatable aeroshell flew on a suborbital trajectory to an altitude of 450 km, was inflated from a 22 inch wide 308 kg capsule into a 10 foot wide aeroshell, and reentered successfully. This inflatable aeroshell, although having the great benefit of being lightweight, experenced 20 gravities of force and 1,000 degrees Fahrenheit of heat load during the suborbital reentry.

Another example of an inflatable aeroshell reentry system is the Russian Inflatable Re-entry and Descent Technology system that was launched to Low Earth Orbit in February 2000 from the Baikonur Cosmodrome. After completing six orbits of the Earth, the system reentered, but it also experienced extreme and uncontrollable thermal and force loads.

It should be noted that both of these inflatable reentry aeroshell vehicles incorporate robust thermal protection systems adapted to withstand ballistic reentry from hypersonic and orbital velocities. Neither of these aeroshell inflatable reentry systems has any means of controlling its trajectory, angle of attack or G force load.

The approaches described in this section are approaches that could be pursued, but not necessarily approaches that have been previously conceived or pursued. Therefore, unless otherwise indicated, it should not he assumed that any of the approaches described in this section qualify as prior art merely by virtue of their inclusion in this section.

### SUMMARY

The present invention is directed at a system, method, or apparatus satisfying the need to overcome the fuel limitations and costs of conventional RCS systems.

An embodiment allows spacecraft attitude control by generating moments about the center of mass, producing an angular acceleration. An embodiment does not require motorized gimbals and spinning rotors to generate a torque force. Rather, torque is generated by producing a friction force on a tether at a distance from an axis of rotation. In accordance with an embodiment, there is a length of tether extending from the forward section of a space capsule in a manner such that the tether's force line is aligned perpendicularly through the capsule's center of mass. “Forward section” as used herein, is in reference to the forward section of a spacecraft during the launching phase. The tether is held by a reel which can vary the length of the section of tether extended from the body of a spacecraft. The tether can be kept enclosed within the capsule during flight and deployed or extended using a reel when the capsule is preparing for re-entry. The reel can be operated by crew members or remotely from a mission control facility on Earth. An excessive length of tether is wound about the reel so that additional tether can be unreeled in the event that part or all of the extended portion of tether is severed or burned away from the spacecraft during re-entry. The tether, when extended from the forward section of the space capsule, functions as a hypersonic parachute, decreasing the capsule's velocity via drag forces.

In accordance with an embodiment, the tether can be made of a heat resistant material with conductive properties making it suitable to function as an antenna. The unexposed end of the tether can be integrated with the spacecraft's radio communications system. The entire length of tether can serve as an antenna for transmitting and receiving radio communications. The reel can feasibly extend the tether to a sufficient length for radio communications to avoid the conductive plasma generated from shock and boundary heating during re-entry, allowing continuous radio communications.

An embodiment, can comprise a “tether direction control apparatus” (hereinafter referred to as “control apparatus”) for offsetting the tether's force line away from a space capsule's center of mass for the purpose of attitude control. If there is no offset, the control apparatus remains in a “zero position”, or centrally aligned with the capsule's z-axis. During re-entry flight, due to drag forces, the extended tether will hold a position parallel to the direction of air resistance relative to the capsule. By offsetting the tether while a drag force is exerted upon it, a moment equal to the drag force multiplied by the distance of the offset from the control apparatus's zero position will be produced about the capsule's center of mass. Moments created by the offset and drag forces can be used to alter pitch, yaw and roll with regards to attitude control.

Certain embodiments can comprise a propellant-based RCS system to serve as a backup system for spacecraft attitude control in the event that a primary tether-based RCS system fails to operate successfully. The propellant-based RCS system functions on the same principle as traditional propellant-based RCS systems, in that it provides attitude control via a series of torque thrusts generated by exhaust of a gas propellant through translation thrusters. The placement of the translation thrusters generally requires that the thrust vector be aligned to pass through the z-axis of the spacecraft or an unwanted roll or rotation will result when the thrusters are fired.

An embodiment's propellant-based RCS system can comprise a ventilation line connected to a backup life support system. For certain embodiments, the propellant comprises compressed oxygen gas. The propellant can comprise a combination of compressed oxygen and other gases (i.e. nitrogen) in a ratio suitable for sustaining human life. In the event that oxygen levels in the passenger cabin fall below a safe level for humans, the backup life support system can be activated by controls within the spacecraft or automatically activated when one or more sensors detect oxygen and/or carbon dioxide levels.

### BRIEF DESCRIPTION OF FIGURES

The present invention is illustrated by way of examples, not by way of limitation, in the figures of the accompanying drawings and in which like reference numerals refer to similar elements and in which:

FIG. 1 illustrates a cut-away side-view of a forward section of a space capsule prior to the re-entry phase, showing a tether-based RCS system comprising a control apparatus and a reel for holding a length of tether, in accordance with an embodiment.

FIG. 2 illustrates a cut-away side-view of a forward section of a space capsule during the re-entry phase, showing a tether-based RCS system comprising a control apparatus and a reel for holding a length of tether and varying the “free tether” length extending outwards from said control apparatus and beyond a spacecraft body, in accordance with an embodiment.

FIG. 3 is a side view of a reel mechanism for holding a length oUether and varying the length of the portion of said tether extending from a spacecraft body, in accordance with an embodiment.

FIG. 4 is a top view of a forward section of a space capsule showing a control apparatus in its zero position, in accordance with an embodiment.

FIG. 5 is a top view of a propellant based backup RCS system, in accordance with an embodiment.

FIG. 6 is a side view of a propellant based backup RCS system, in accordance with an embodiment.

FIG. 7 is a top view of a forward section of a space capsule showing a control apparatus in a “y-axis” offset position, in accordance with an embodiment.

FIG. 8 is a side view showing the effect of a tether's “y-axis” offset, in accordance with an embodiment.

FIG. 9 is a top view of a forward section of a space capsule showing a control apparatus in an “x-axis” offset position, in accordance with an embodiment.

FIG. 10 is a side view showing the effect of a tether's “x-axis” offset, in accordance with an embodiment.

FIG. 11 shows a side view of a space capsule with a tether-based RCS system and illustrates how the RCS system induces attitude control by producing a moment generated by offsetting a tether from a space capsule's z-axis, in accordance with an embodiment.

FIG. 12 is a side view illustrating the steps by which a space capsule uses a tether-based RCS system to adjust pitch to decrease a space capsule's angle of attack with respect to the atmosphere, in accordance with an embodiment.

FIG. 13 is a side view illustrating the steps by which a space capsule uses a tether-based RCS system to adjust pitch to increase a space capsule's angle of attack with respect to the atmosphere, in accordance with an embodiment.

FIG. 14 is a top view looking down on a space capsule re-entering the atmosphere, illustrating the steps by which said space capsule uses a tether-based RCS system to adjust yaw to steer said space capsule's approach vector to the right of the z-axis, relative to said capsule's orientation in the present illustration, in accordance with an embodiment.

FIG. 15 is a top view looking down on a space capsule re-entering the atmosphere, illustrating the steps by which said space capsule uses a tether-based RCS system to adjust yaw to steer said space capsule's approach vector to the left of the z-axis, relative to said capsule's orientation in the present illustration, in accordance with an embodiment.

FIG. 16 is an isometric drawing of an embodiment that comprises an aerodynamic decellerator comprising a tether, an aerodynamic vehicle comprising an inflatable aeroshell reentry system, and a control system that connects the tether to the vehicle, the control system comprising three lines whose length can be mechanically varied to change the angle of attack of the vehicle.

FIG. 17 shows an embodiment comprising a tether RCS attached to an Excalibur Almaz reuseable reentry vehicle.

FIG. 18 shows an embodiment comprising a tether RCS attached to a US Air Force X-37B robotically controlled reusable spacecraft.

FIG. 19 shows an embodiment comprising a tether RCS attached to a Russian Soyuz single use reentry vehicle.

FIG. 20 shows details of an example control apparatus.

FIG. 21 illustrates a trajectory according to an example method for atmospheric skip entry.

### DETAILED DESCRIPTION

In the following description, for purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

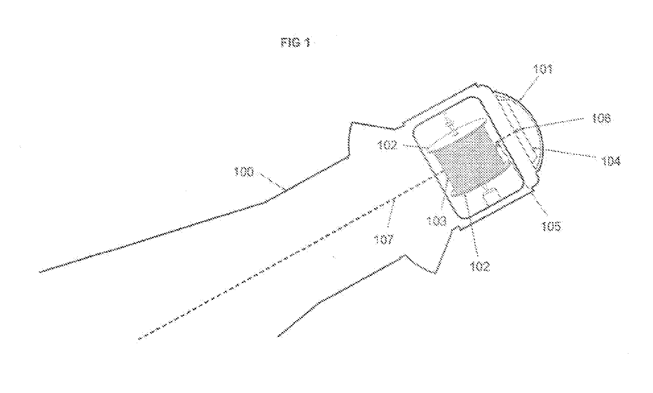

FIG. 1 illustrates a cut-away side-view of a forward section of a space capsule 100 prior to the re-entry phase, showing a tether-based RCS system comprising a control apparatus 104 and a reel 102 for holding a length of tether 103, in accordance with an embodiment. Prior to re-entry, the opening at the end of the forward section of the capsule is covered by a lid 101 for keeping an initial length of unreeled tether 105 confined within the capsule. The un-reeled tether 105 is the portion of tether held by the reel 102 that is threaded through a “center hole” 106 of the control apparatus 104 and is initially coiled and stored above the control-apparatus 104. As used herein, “center hole” or the like refers to the hole in the center of the control apparatus 104 through which a tether 103 is threaded. The control apparatus 104 is initiaily in a zero position. As used herein, zero position refers to the default position where the control apparatus' center hole is directly aligned with a spacecraft's z-axis 107 that passes through a spacecraft's center of mass.

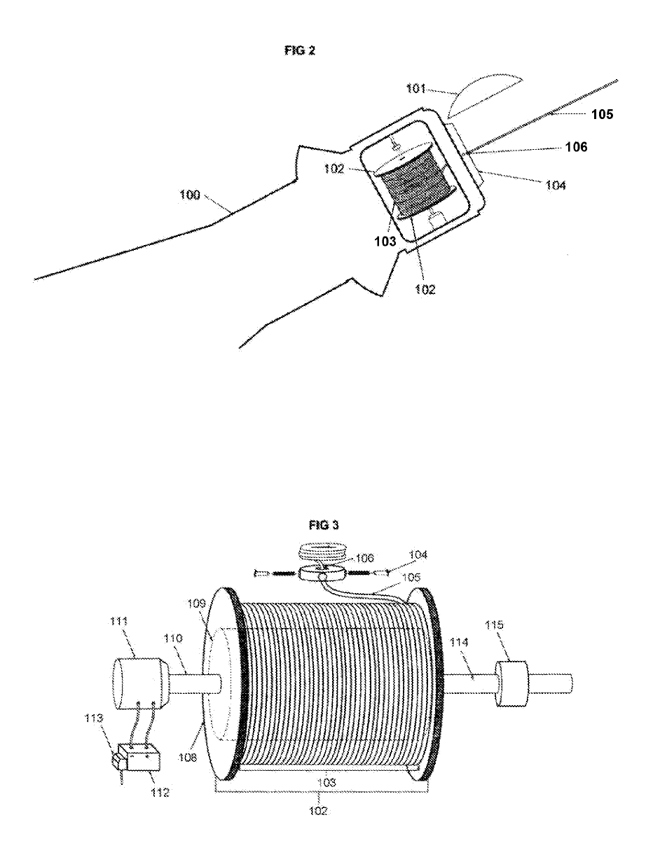

FIG. 2 illustrates a cut-away side-view of a forward section of a space capsule 100 during reentry, showing a tether-based RCS system comprising a control apparatus 104 and a reel 102 for holding a length of tether 103 and varying the length of a portion of “free tether” 105, in accordance with an embodiment. As used herein, “free tether” or the like refers to the portion of a tether 103 which extends outwards from the control apparatus 104 and beyond a spacecraft's body.

A lid 101 covering the opening at the forward section of the capsule detaches from the capsule body 100 during re-entry and prior to the release of the tree tether 105 from the capsule body 100, The detachment may be triggered via controls within the capsule or remotely from a mission control facility on Earth. At this point, the lid 101 can be considered to be a discarded expendable component. The free tether 105 is released from the capsule 100. The tether 105 remains threaded through the center hole 106 of the control apparatus 104 and held in place by the reel 102. The control apparatus 104 is initially in a zero position.

FIG. 3 is a side view of a reel mechanism 102 for holding a length of tether 103 and for varying the length of the free tether 105, in accordance with an embodiment. The reel 102 comprises two circular flanges 108 and a cylindrical shaft 109 situated horizontally between said circular flanges 108, said circular flanges 108 having equal radii substantially larger than the radius of said cylindrical shaft 109.

Each end of the cylindrical shaft 109 is connected to the center of a circular flange 108. During flight, the tether 103 is stored by being wound around the cylindrical shaft 109 on the reel 102, between the flanges 108. One circular flange 108 is connected to a driveshaft 110, said driveshaft 110 being further connected to a motor 111. The motor 111 is bi-directional and turns the driveshaft 110 clockwise or counter-clockwise. When driven by the motor 111, the driveshaft 110 turns the reel 102 accordingly and retracts or extends the tether 103 depending on the direction of the motor. In this embodiment, turning the driveshaft 110 counter-clockwise extends the tether, or causes free tether 105 to lengthen, and turning the driveshaft 110 clockwise retracts the tether 103 shortening the free tether 105, The motor 111 is powered by a power source 112, and can be controlled via an interface 113 from the spacecraft's controls. The free tether 105 remains threaded through the center hole 106 of a control apparatus 104, initially in a zero position. The free tether 105 remains loosely coiled above the control apparatus 104 and remains so until the spacecraft is ready for atmospheric re-entry. On re-entry, the free tether 105 is released into the atmosphere and drags behind the spacecraft, serving as a hypersonic parachute. The unexposed end 114 of the tether 103 is interfaced with the spacecraft's radio communications system 115, allowing the tether 103 to function as a radio antenna during atmospheric re-entry. Highly conductive plasma forms as a result of shock and boundary layer heating during atmospheric re-entry, blocking radio waves. The free tether 105 extends far behind the spacecraft, avoiding the conductive plasma and allowing the spacecraft to send and receive radio transmissions during re-entry. The tether 103 is made of a heat-resistant conductive material such as aluminum or steel for sending and receiving radio communications and withstanding the high temperature of the conductive plasma.

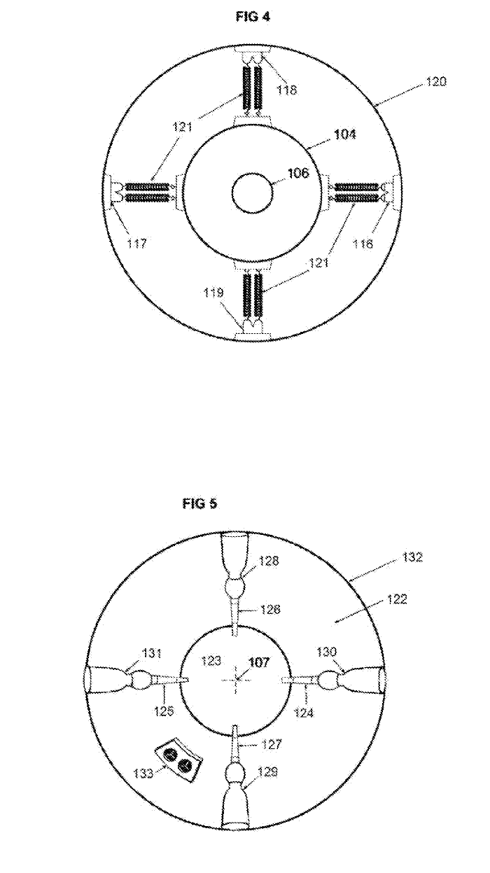

FIG. 4 is a top view of a forward section of a space capsule showing a control apparatus 104 in the zero position, in accordance with an embodiment of the present invention. The control apparatus 104 is connected to four identical retracting arms 116, 117, 118, 119 equidistant from each other along the inner hull 120 of the space capsule. Relative to the x-y axes as shown in FIG. 4, the retracting arms 116, 117, 118, 119 are denoted as follows: “positive-x” 116, “negative-x” 117, “positive-y” 118, and “negative-y” 119. The control apparatus 104 has a center hole 106 through which a tether is threaded. Initially, the control apparatus 104 is in the zero position. The retractable arms 116, 117, 118, 119 are connected to the control apparatus 104 by a total of eight identical tension springs 121, designed to become longer under load. Each arm 116, 117, 118, 119 is connected to the control apparatus 104 by two tension springs 121. When one of the retracting arms 116, 117, 118, 119 retracts into the inner hull 120, a load affects all the springs 121. The tension springs 121 have turns normally touching in the unloaded position, and the springs 121 have a hook, eye, or some other means of attachment at each end connecting it to the retracting arms 116, 117, 118, 119 and the control apparatus 104.

FIG. 5 is a top view of a propellant based backup RCS system, in accordance with an embodiment. The propellant based RCS system also concurrently functions as part of a backup life support system. The propellant can comprise compressed oxygen, or a combination of compressed oxygen and other gases in a ratio suitable for sustaining human life (i.e. appropriate mixture of oxygen and nitrogen). The propellant is stored in a gas propellant tank 122. There is a central hub mechanism 123 connecting the tank 122 to four gas lines denoted as: positive-x 124, positive-y 126, negative-x 125, and negative-y 127, relative to the x-y axes shown in FIG. 5. The opposite ends of the gas lines 126, 127, 124, 125 are connected to translation thrusters 128, 129, 130, 131 used to alter the spacecraft's velocity or attitude (pitch, yaw, roll). Each thruster 128, 129, 130, 131 has a nozzle directed perpendicularly outward from the capsule's hull 132. Translation thrusters 128, 129, 130, 131 is that should align with the z-axis 107 of the capsule to avoid unwanted roll or rotation when the thruster is fired. Torque thrust is produced by the gas propellant leaving the nozzle as exhaust. A control system inside a spacecraft controls the release of the gas propellant into the gas lines 126, 127, 124, 125, said control system having the ability to selectively release the propellant into single or multiple gas lines.

While the spacecraft has a primary life-support system, the backup RCS system further functions as part of a backup life support system, supplying the breathable gas propellant to the human occupants of the spacecraft should the oxygen or carbon dioxide levels reach a predetermined danger threshold and/or the primary life-support system fails. The gas propellant tank 122 is further connected to a backup life-support system 133 by a ventilation line 134. The backup life-support system comprises carbon dioxide canisters, fans, and filters. The carbon dioxide canisters remove carbon dioxide by reacting it with another chemical (i.e. lithium hydroxide, calcium hydroxide, sodium hydroxide), and the fans and filters remove dust and trace odors from within the spacecraft. The backup life-support system can be activated manually by controls within the spacecraft, or automatically when one or more sensors detect that oxygen or carbon dioxide concentrations have reached an unsafe level. FIG. 6 is a side view of a propellant based backup RCS system, in accordance with an embodiment. The backup RCS system is located, relative to the tether RCS system comprising the reel 102 and control apparatus 104. A central hub mechanism 123 connects a gas propellant tank 122 to four gas lines 124, 125, 126, and 12. The opposite ends of the gas lines are connected to translation thrusters denoted as: positive-x 128, negative-x 129, positive-y 130 and negative-y 131, with respect to the x-y axes shown in FIG. 10. The translation thrusters 128, 129, 130, 131 are used to alter the spacecraft's velocity or attitude (pitch, yaw, roll angles). Each thruster 128, 129, 130, 131 has a nozzle directed perpendicularly outwards from the capsule's hull 132. The translation thrusters 128, 129, 130, 131 should align with the capsule's z-axis 107. Torque thrust is produced by gas propellant leaving a nozzle as exhaust. A control system inside a spacecraft controls the release of gas propellant into the gas lines. The control system has the ability to selectively release the propellant into single or multiple gas lines.

The backup RCS also functions as part of a backup life support system 133 comprising fans and filters for removing dust, odors, and carbon dioxide. The gas propellant tank 122 is connected to the backup life support system by a ventilation line 134 and can be activated manually by controls within the spacecraft, or automatically when one or more sensors detect that oxygen or carbon dioxide concentrations have reached an unsafe level.

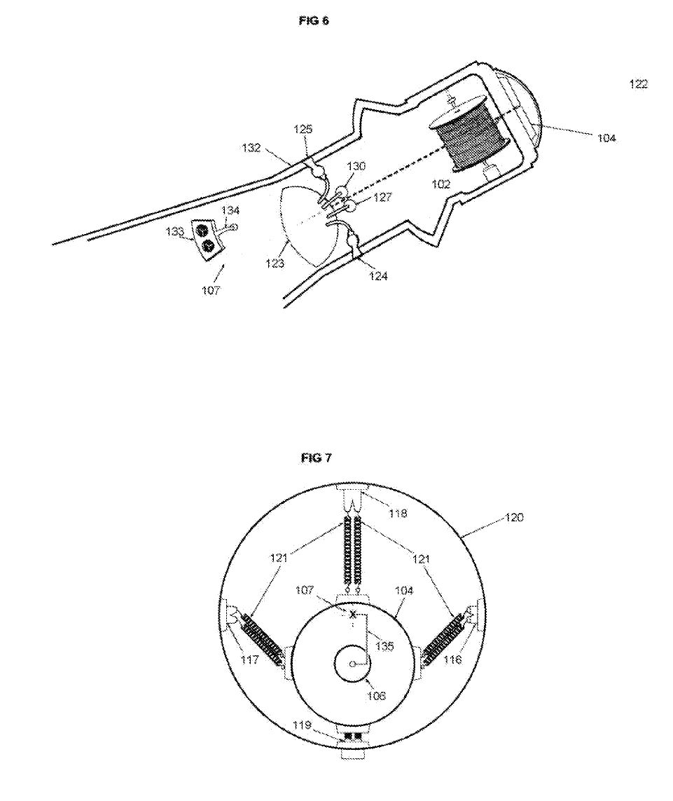

FIG. 7 is a top view of a forward section of a space capsule showing the operation of the control apparatus 104, in accordance with an embodiment of the present invention. The control-apparatus 104 is connected to four identical retracting arms 116, 117, 118, 119 equidistant from each other along the inner hull 120 of the space capsule. Relative to the x-y axes as depicted in FIG. 7, the retracting arms are denoted as follows: “positive-x” 116, “negative-x” 117, “positive-y” 118, and “negative-y” 119. The retractable arms 116, 117, 118, 119 are connected to the control apparatus 104 by eight identical tension springs 121, designed to become longer under load. Each arm 116, 117, 118,119 is connected to the control apparatus 104 by two tension springs 121.

In FIG. 7, the “negative-y” arm 119 is in a retracted position, the body of the arm having been retracted into the inner hull 120 of the space capsule by a retraction means. The retraction of the negative-y arm 116 increases the distance between said negative-y ann 119 and the positive-y arm 118, creating a load on all the springs 121. The load is caused by a movement in the negativey direction, causing the control apparatus 104 to also move in the negative-y direction.

The springs 121 attaching the positive-x and negative-x arms 116, 117 to the control apparatus 104 are also pulled in the negative-y direction by the ends of the springs 121 attached to said control-apparatus 104. The effect is that the center hole 106 is offset from the z-axis 107 in the negative-y direction by the measurement equal to the distance 135 from the center hole's 106 current position and its original zero position. A tether threaded through the center hole 106 would similarly be offset from the z-axis 107.

FIG. 8 shows a cut-away side view of the forward section of a space capsule 100 showing an offset 135 of the tether 105 in the negative-y direction due to a retraction of the positive-y arm, in accordance with an embodiment. The tether 105 is attached to and wound around a reel 102, said reel 102 being attached to the capsule body 100, said tether threaded through the center hole 106 of the control apparatus 104. The control apparatus 104 is connected to four retractable arms by tension springs 121.

A retraction of the negative-y arm 119 into the capsule's hull 132 creates a load affecting the tension springs 121 in the negative-y direction. As a result, the control apparatus 104 is pulled in the negative-y direction, and a tether 105 threaded through the center hole 106 is offset from the capsule's 100 z-axis 107 by a distance 135 equal to the difference between the center hole's 106 current position and its original zero position.

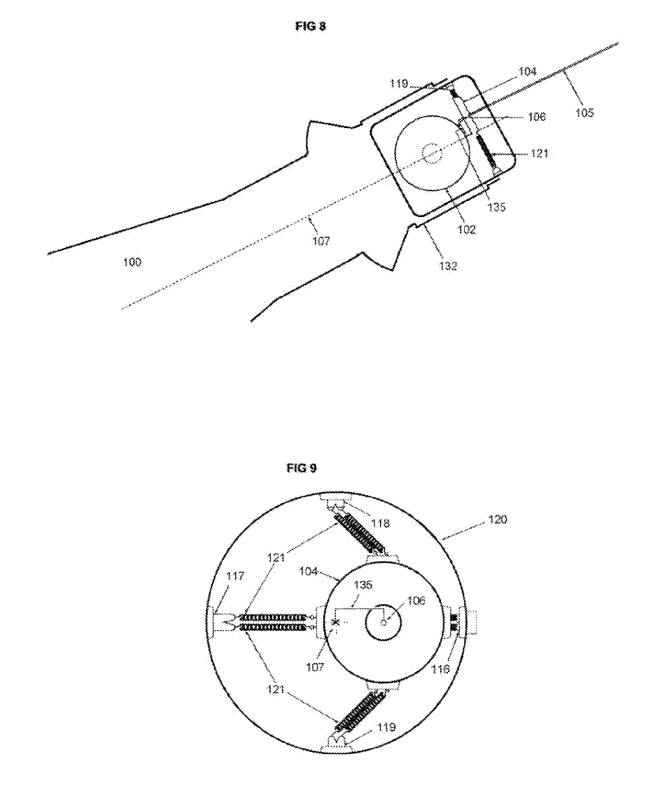

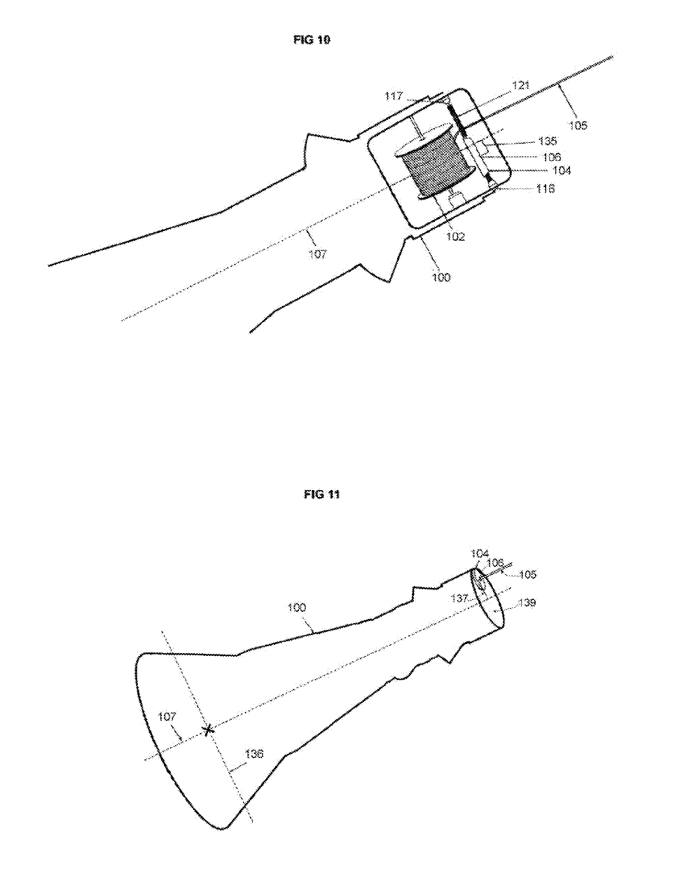

FIG. 9 is a top view of a forward section of a space capsule showing the operation of the control apparatus 104, in accordance with an embodiment. The control apparatus 104 is connected to four retracting arms 116, 117, 118, 119 equidistant from each other along the inner hull 120 of the space capsule.

Relative to the x-y axes as depicted in FIG. 9, the retracting arms are denoted as follows: “positive-x” 116, “negative-x” 117, “positive-y” 118, and “negative-y” 119. The retractable arms 116, 117, 118, 119 are connected to the control apparatus 104 by eight identical tension springs 121, designed to become longer under load. Each arm 116, 117, 118, 119 is connected to the control apparatus 104 by tension springs 121.

In FIG. 9, the positive-x arm 116 is in a retracted position, the body of the arm having been retracted into the inner hull 120 of the space capsule by a retraction means. The retraction of the positive-x arm 116 increases the distance between said positive-x arm 116 and the negative-x arm 117. The retraction of the positive-x arm 116 creates a load on all the springs 121. The load is caused by a movement in the positive-x direction, causing the control apparatus 104 to also move in the positive-x direction. The springs 121 attaching the positive-y and negative-y arms 118, 119 to the control apparatus 104 are also pulled in the positive-x direction by the ends of the springs 121 attached to the control apparatus 104. The effect is that center hole 106 is offset from the z-axis 107 in the positive-x direction by the measurement equal to the distance 135 from the center hole's current position and the zero position. A tether threaded through the center hole 106 would similarly be offset from the z-axis 107.

FIG. 10 shows a cut-away side view of the forward section of a space capsule 100 showing an offset 135 of the tether 105 in the positive-x direction after a retraction of the positive-x arm 116, in accordance with an embodiment. The tether 105 is attached to and wound around a reel 102, said reel 102 being attached to the capsule body 100, said tether threaded through the center hole 106 of the control apparatus 104. The control apparatus 104 is connected to the four retractable arms by tension springs 121. A retraction of the positive-x arm 116 into the capsule's hull 132 creates a load affecting the tension springs 121 in the positive-x direction. As a result, the control apparatus 104 is pulled in the positive-x direction, and a tether 105 threaded through the center hole 106 is offset from the capsule's z-axis 107 by a distance 135 equal to the difterence between the center hole's 106 current position and its original zero position.

FIG. 11 shows a cut-away side view of a space capsule 100 with a tether RCS system and illustrates how the RCS system induces attitude control by producing a moment by offsetting a tether 105 from a space capsule's z-axis, in accordance with an embodiment. The tether RCS system has a reel 102 for holding a length of tether 105. The tether 105 is threaded through the center hole 106 of a control apparatus 104, said control apparatus 104 initially in the zero position.

A moment is a rotational effect produced by a force at some distance from an axis of rotation. The moment (M) is equal to the product of the force (F) and the distance (d) from the axis of rotation about which it is applied. In FIG. 11 the control apparatus 104 has shifted the tether 105 along the capsule's x-axis 136 above and out of alignment with the capsule's center of mass line z-axis 107, creating an offset or moment arm 137. The tether's collision with molecules in the atmosphere creates a friction force 138.

The line that passes through the capsule's center of gravity and is perpendicular to both the capsule's z-axis 136 and said moment arm 137 is the axis of rotation and in this case happens to be the y-axis. Moment 139 is the product of the friction force produced by tether 138 and the offset 137, a distance equal to the difference between the center hole's 106 current position and z-axis. Here, the moment 139 acts about the capsule's center of mass in the clockwise direction, as viewed in FIG. 11. The effect of the moment 139 is that the capsule's angle of attack, relative to the atmosphere, decreases. In flight dynamics, this angle is called pitch.

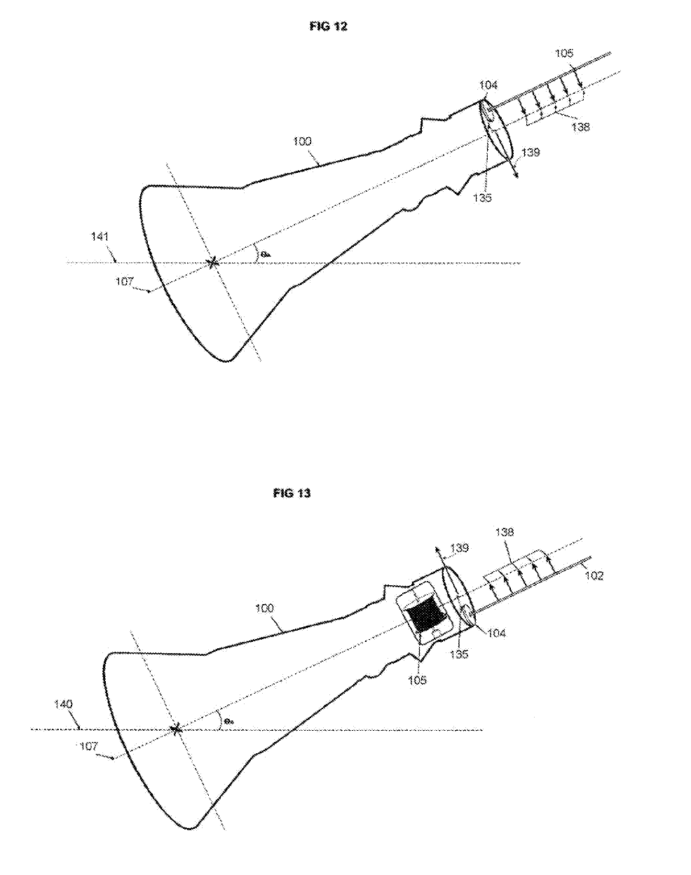

FIG. 12 illustrates the steps by which a space capsule 100 uses a tether-based RCS system to adjust pitch to decrease a space capsule's angle of attack, θ_{A}, with respect to the atmosphere 140, in accordance with an embodiment. θ_{A} is the angle formed by the capsule's 100 z-axis 107 and the atmosphere 140. The tether based RCS system comprises of a reel 102 for holding a length of tether 105 and a control apparatus 104. The control apparatus 104 and the tether 105 are initially in the zero position. In FIG. 12, the control apparatus 104 offsets the tether 105 away from the z-axis 107. As a result, the tether 105 is offset in a direction away from the atmosphere 140 by a distance 135 equal to the difference between the zero position and the tether's current position.

A friction force 138 is produced by the entire length of tether 105 colliding with molecules in the atmosphere 140. Because the friction force 138 is produced at a distance 135 from the z-axis 107, a moment 139 is produced, causing a rotational effect about the capsule's 100 center of mass 141. The spacecraft 107 rotates in a clockwise direction, closer to the atmosphere 140, by using the center of mass 141 as a pivot point, decreasing θ_{A}. The end result is that by offsetting the tether 105, the capsule 100 has adjusted pitch by decreasing θ_{A} for atmospheric reentry using the rotational effected generated by a moment 139.

FIG. 13 illustrates the steps by which a space capsule 100 uses a tether-based RCS system to adjust pitch to increase a space capsule's angle of attack, θ_{A}, with respect to the atmosphere 140, in accordance with an embodiment. θ_{A} is the angle formed by the capsule's z-axis 107 and the atmosphere 140. The tether based RCS system comprises a reel 102 for holding a length of tether 105 and a control apparatus 104. The control apparatus 104 and the tether 105 are initially in the zero position. In FIG. 13, the control apparatus 104 offsets the tether 105 away from the z-axis 107. As a result, the tether 105 is offset in a direction to'vvards the atmosphere 140 by a distance 135 equal to the difference between the zero position and the tether's current position.

A friction force 138 is produced by the entire length of tether 105 colliding with molecules in the atmosphere 140. Because the friction force 138 is produced at a distance 135 from the z-axis 107, a moment 139 is produced, causing a rotational effect about the capsule's 100 center of mass 141. The z-axis 107 moves in a counterclockwise direction, further from the atmosphere 140 by using the center of mass 141 as a pivot point, increasing θ_{A}. The end result is that by offsetting the tether 105, the capsule 100 has adjusted pitch by increasing θ_{A} for atmospheric reentry using the rotational effect generated by a moment 139.

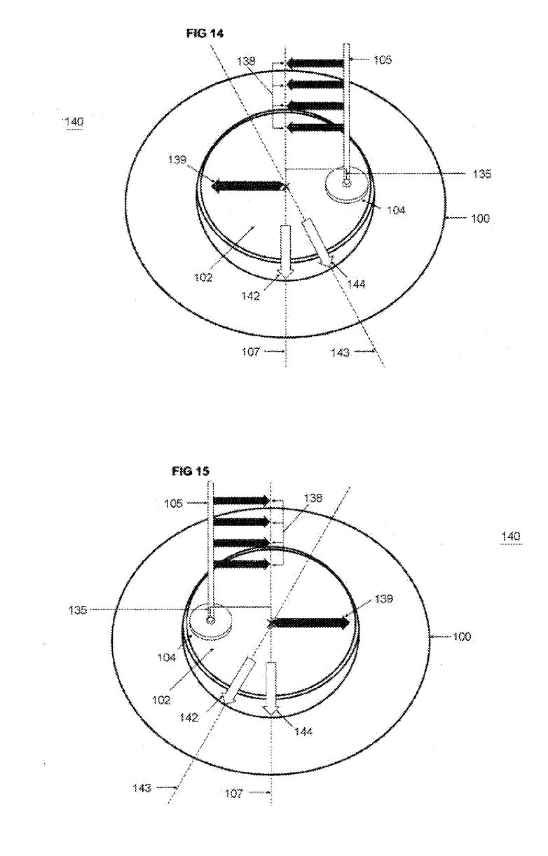

FIG. 14 is a top view looking down on a space capsule 100 re-entering the atmosphere 140, illustrating the steps by which said space capsule 100 uses a tether-based RCS system to adjust yaw to steer said space capsule's 100 approach vector 142 to the right of the z-axis 107, relative to said capsule's 100 orientation in this illustration, in accordance with an embodiment. The tether-based RCS system comprises a reel 102 for holding a length of tether 105 and a control apparatus 104. The control apparatus 104 and tether 105 are initially in the zero position. In FIG. 14, the control apparatus 104 offsets the tether 105 to the right of the z-axis 107 by a distance equal to the difference between the zero position and the tether's 105 current position.

A friction force 138 is produced by the entire length of tether 105 colliding with molecules in the atmosphere 140. Because the friction force 138 is produced at a distance 135 from the z-axis 107, a moment 139 is produced, causing a rotational effect about the capsule's 100 center of mass 141. The z-axis 107 is shifted in a clockwise direction, relative to the capsule's 100 orientation in this illustration, using the center of mass 141 as a pivot point. The z-axis's new position 143 acts as the capsule's new approach vector 144. The end result is that by offsetting the tether 105, the capsule 100 has adjusted yaw and steered its direction to a new approach vector 144 which is to the right of the original approach vector 142, relative to the capsule's 100 orientation in this illustration.

FIG. 15 is a top view, looking down on a space capsule 100 re-entering the atmosphere 140, illustrating the steps by which said space capsule 100 uses a tether-based RCS system to adjust yaw to steer said space capsule's approach vector 142 to the left of the z-axis 107, relative to said capsule's orientation in this illustration, in accordance with an embodiment. The tether-based RCS system comprises a reel 102 for holding a length of tether 105 and a control apparatus 104. The control apparatus 104 and the tether 105 are initially in the zero position. In FIG. 15, the control apparatus 104 offsets the tether 105 to the left of the z-axis 107 by a distance equal to the difference between the zero position and the tether's 105 current position.

A friction force 138 is produced by the entire length of tether 105 colliding with molecules in the atmosphere 140. Because the friction force 138 is produced at a distance 135 from the z-axis 107, a moment 139 is produced, causing a rotational effect about the capsule's center of mass 141. The z-axis 107 is shifted in a counter-clockwise direction relative to the capsule's orientation in this illustration, using the center of mass 141 as a pivot point. The z-axis's new position 143 acts as the capsule's new approach vector 144. The end result is that by offsetting the tether 105, the capsule 100 has adjusted yaw and steered its direction to a new approach vector 144 which is to the left of the original approach vector 142, relative to the capsule's orientation in this illustration.

An example device comprises an aerodynamic decellerator for producing a tension force from aerodynamic drag, a vehicle capable of producing lift force that changes as the angle of attack varies, and a controller connected to the decellerator and also connected to the aerodynamic vehicle, for applying the tension force produced by the decellerator to the vehicle in a controlled manner to change the vehicle's angle of attack, thus varying the lift force produced by the vehicle. An example method is to adjust the load vector applied to a reentry vehicle by an aerodynamic decelerator to accomplish controlled skip entry through the upper atmosphere thereby reducing the vehicle's forward velocity vector and minimizing dynamic and thermal loads.

An illustrative embodiment comprises an aerodynamic decellerator for producing a tension force from aerodynamic drag, a vehicle capable of producing lift force that varies with angle of attack, and a control device connecting the aerodynamic decellerator to the aerodynamic vehicle, for applying the tension force produced by the decellerator to the vehicle in a controlled manner to change the vehicle's angle of attack, thus varying the lift force produced by the vehicle. An example method comprises using the devices described herein to accomplish controlled skip entry through the upper atmosphere in order to more gradually reduce the vehicle's forward velocity vector and thereby reduce dynamic and thermal loads.

A pull point is a point where drag generated by a tether is exerted on a space craft. For inflatable structures, rigidity is the degree of pressurization sufficient to retain structural integrity despite forces encountered during atmospheric entry. Skip entry is a method of atmospheric entry comprising one or more “skips” off of the atmosphere where energy is lost.

An example atmospheric entry device comprising a controllable tether and an aerodynamic body can use a skip entry technique.

Frictional drag force applied to a tether induces tension in the tether. An example device can comprise a tether attached to an aerodynamic body and a tether controller that shifts the pull point's location.

Atmospheric re-entry, even when initiated from a circular low-Earth orbit, typically requires a thermal protection system comprising a heat shield, ablative material, or radiative dissipation techniques. Semi-analytical and numerical simulations of the atmospheric re-entry from low-Earth orbits of a capsule with a 20-km heat resistant tether attached have shown that the thermal input flux on the capsule is reduced by more than one order of magnitude with respect to a comparable re-entry without a tether.

Long tethers have low ballistic coefficients and a large surface for heat dissipation. Moreover, a long tether is stabilized by gravity gradient and consequently tends to maintain a high angle of attack with respect to the wind velocity. The exposed surface of a 20 kilometer long 1 milimeter diameter tether is 20 square meters, which is larger than the typical cross section of a re-entry capsule. For example, the apollo command module's cross section is under 12 square meters. The resulting strong drag decelerates the capsule during re-entry. Where an example embodiment allows variance of the application of drag force to the re-entry vehicle, so that the force vector is offset from the vehicle's center of mass, to change the vehicle's angle of attack, allowing control of the vehicle's reentry flight path. By using this method to allow the reentry vehicle to skip in and out of the atmosphere, especially during the portion of the reentry process where the greatest thermal and mechanical loads are produced, extends the time of reentry flight in a controlled manner and reduces the peak mechanical and thermal forces acting on the reentry vehicle.

A device, and the method of its use, for controlled atmospheric entry allows for an atmospheric entry system (“system”) that may be controlled in order to produce a flight path having reduced deceleration loads over an extended period of time in order to decrease mechanical and thermal loads and stresses that occur during atmospheric entry. This will allow for a gentler more precisely controlled transit through an atmosphere.

An embodiment can be used with any spacecraft design that produces lifting force that can be varied by varing the vehicle's angle of attack. A winged shuttle, a lifting body, and a space capsule are all examples of such spacecraft. An embodiment can work with an inflateable reentry system that uses a pressurized flexible toroid to provide rigid support to a flexible conical aeroshell payload section. Synergistic benefits may be obtained by using a lightweight inflatable reentry vehicle in conjunction with an embodiment.

### Aerodynamic Vehicle (100):

An inflatable aeroshell is an example of the type of aerodynamic vehicle discussed in the embodiment below. Examples of inflatable aeroshells comprise the NASA inflatable aeroshell and the Russian inflatable aeroshell. These inflatable aeroshells have the benefit of being lightweight. They also have the disadvantage of only operating in an uncontrolled ballistic reentry trajectory, which produces large thermal and mechanical loads.

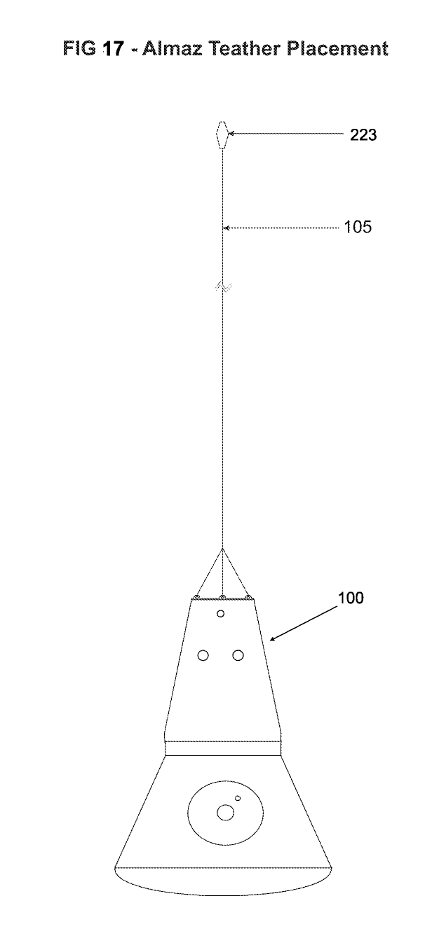

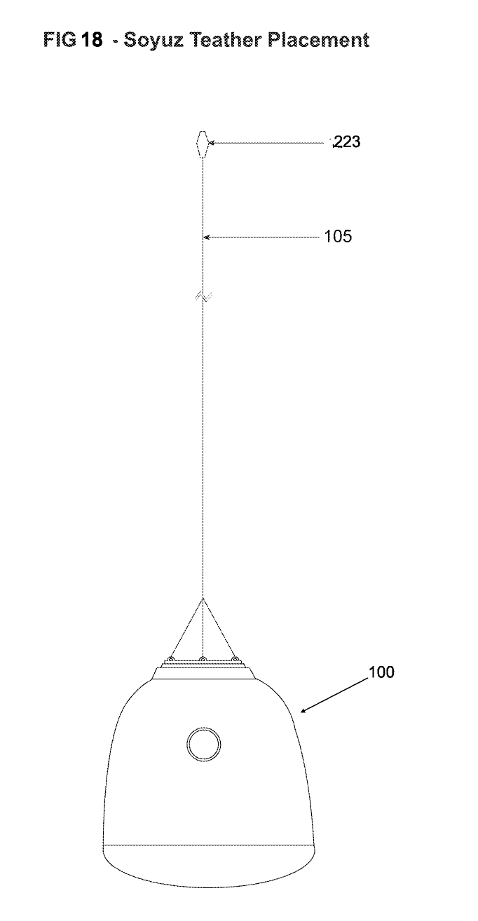

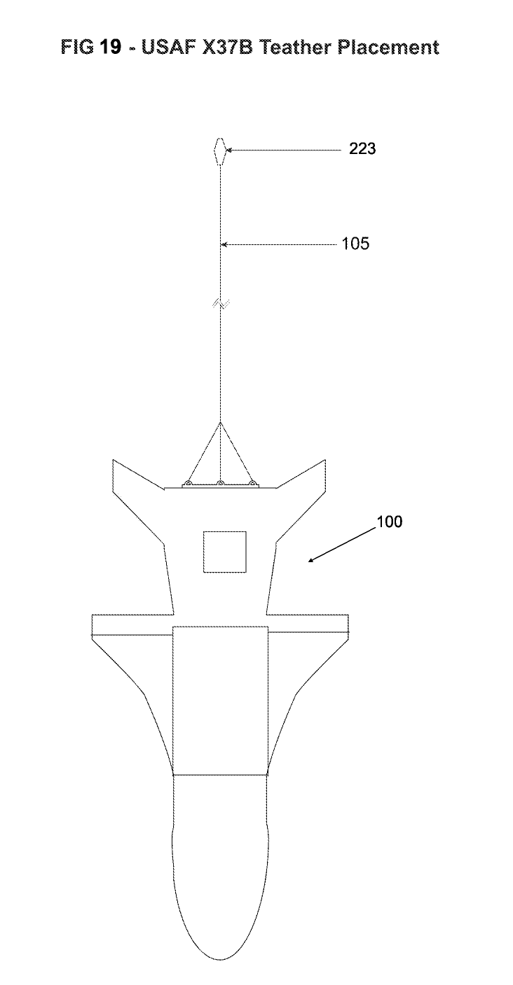

An aerodynamic reentry vehicle capable of producing variable lift force when its angle of attack is varied may also be used. Examples of such vehicles include the USAF X37B robotic reuseable reentry spacecraft as shown in FIG. 18, the Soyuz and Shinzu single use reentry vehicles illustrated in FIG. 19, and the Excalibur Almaz reuseable reentry vehicle, as shown in FIG. 17.

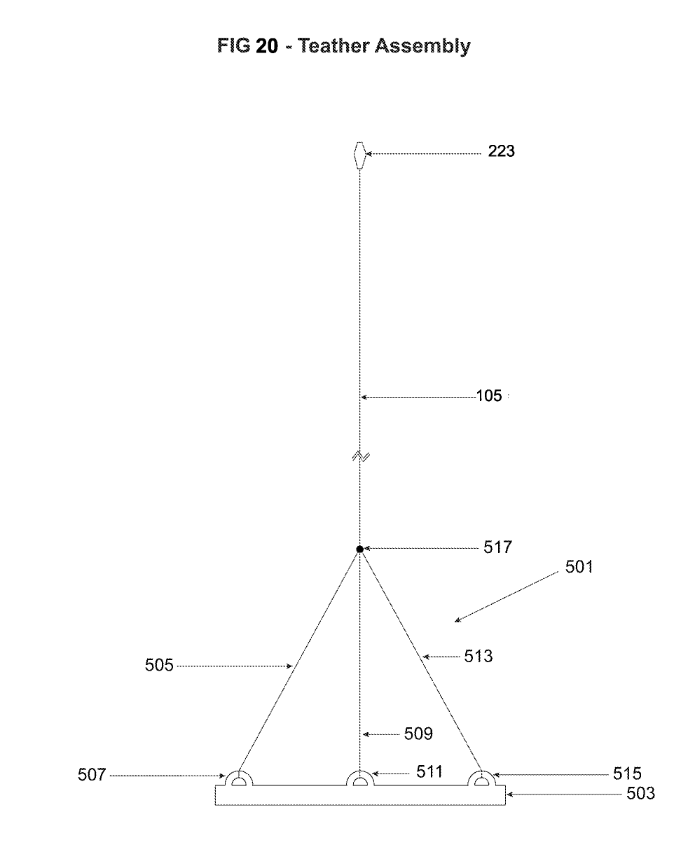

FIG. 20 shows a detail view of the tether control shown in FIGS. 17, 18 and 19. In FIG. 20, controller 501 comprises a structural attachment point of the return vehicle 503. Control line control means 507, 511 and 515 are connected to one end of control lines 505, 509 and 515, respectively. The control line control means are adapted to be able to reel the control lines in and out so as to change their length in a controlled fashion. The end of these control lines are affixed to one end of tether 105 at point 517. Changing the length of the control lines varies the point of action of the tension force from the tether on the vehicle so as to control the vehicle's angle of attack.

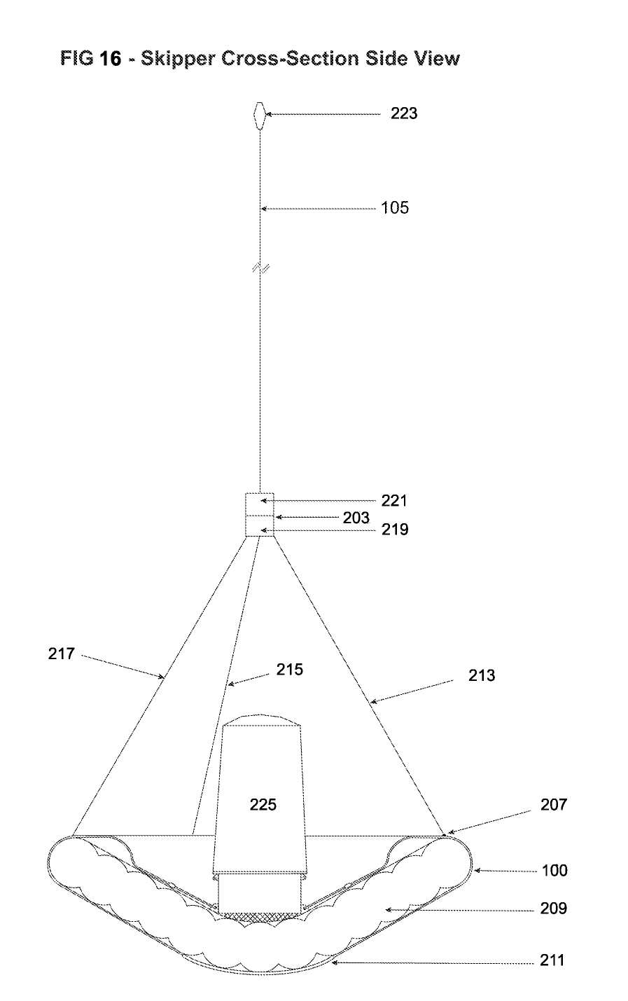

FIG. 16 shows an embodiment comprising an inflateable aeroshell 100 and an Inflatable Aeroshell Toroid 207. The toroid 207 of aeroshell 100 is made of a material such as Kevlar such that the interior of toroid 207 is not in fluid communication with the exterior of the toroid. For storage and transportation the toroid may be deflated. During atmospheric entry, toroid 207 will be inflated causing toroid 207 to be pressurized to a point of rigidity to retain structural integrity despite the forces acting on it during the controlled atmospheric entry process.

The inflatable aeroshell skin 209 is fixedly attached to the exterior surface of toroid 207 at one or more locations about the circumference of the exterior surface of the toroid (possibly continuously attached such that there is no fluid communication between the inflatable toroid and the skin), and extends below the center of the toroid, forming an inverted payload volume 225. The skin being positioned in such a way that it forms a conical shape extending below the toroid. Skin 209 may be made of any material having mechanical strength sufficient to support the payload during reentry. It may be adapted to protect payload 225 against heating and may optionally comprise a thermal protection material 211.

The aerodynamic body 100 comprises the toroid 207 and the skin 209 that extends from the toroid, forming a conical nose 211 that sits underneath the toroid. This aerodynamic body automatically orients the entry system due to the action of natural aerodynamic forces in such a way as to have the aerodynamic body sit between the payload and the source of gravity with the nose-cone 211 pointing toward the gravitational source. Although an embodiment can reduce the thermal and mechanical loads acting on the reentry system and payload, it does not eliminate these loads entirely. The aerodynamic body therefore also shields the payload of the system from the majority of the frictional and thermal forces generated by the device's controlled transit through the atmosphere.

The inflatable aerodynamic body acts as a lift generating body, aerodynamically orients and stabilizes the system, protects the rest of the system from friction with the atmosphere, can act as a backup life support system if it is pressurized with breathable gas, and may be provided with air bags to cushion the impact of the system when it impacts the surface of the celestial body.

The tether 105 is attached to the vehicle 100 by control system 203. The tether can be deployed by any number of different tether deployment means.

The tether 105 is attached by any suitable mechanical means to the tether controller 203. The tether extends from the tether controller 203 to the tether end point 223. The tether 105 is deployed by a tether deployment means 158 and extends out behind the aerodynamic body 100. When the tether is extended it begins colliding with the molecules that constitute the atmosphere, causing friction. The friction generated by the tether exerts a drag force which is communicated to the rest of the atmospheric entry device at the Pull Point. If the tether is 20-km-long and 1-mm diameter tether, then its surface area is 20 square meters, which is much larger than the cross section of a re-entry capsule. For example the aerodynamic surface area of the 10 foot diameter NASA inflatable reentry system is about seven square meters.

The tether controller 203 is attached to tether 105 and through controllable lines 213, 215 and 217 to the exterior surface of the toroid. In FIG. 16 these three lines are attached to the toroid every 120 degrees around the toroid in such a way as to allow the tether controller 203 line actuator 219 the ability to change the length of control lines 213, 215 and 217 to change the angle of attack of the vehicle 100 with respect to the relative wind. The tether controller 203 tether length controller 158 can modify the aerodynamic characteristics of the tether by extending the tether, retracting the tether, altering the angle of the tether with respect to the main body of the atmospheric entry device, or altering the location at which the force being exerted on the tether is functionally communicated to the rest of the device (“Pull Point”).

The tether control lines 213, 215 and 217 and the tether 105 itself can be extended or retracted by electric motors, by hydraulic or pneumatic actuators or even by manually pulling or winding the lines by mechanical means. This opens up the rather interesting possibility of extreme sports enthusiasts surfing the upper atmosphere from orbit.

In the lower atmosphere and at low, subsonic, speeds tether 105 may not generate a great deal of drag. Certain embodiments could incorporate a parachute into tether controller 203. This parachute could be deployed prior to landing. Alternatively, a deployable lighter than air balloon could be incorporated into the system to inflate to let the payload float in the atmosphere. Finally, the payload, with a balloon or parachute system, could be ejected after reentry, but prior to landing. An embodiment could also incorporate inflatable air bags or foam cushions to reduce the effect of the landing impact on the payload.

### Inflation Means:

In one or more embodiments, the aerodynamic body comprises toroid, a skin, a payload volume, and one or more tether attachment points (possibly comprising a controller). There could be a way of going from a compacted deflated state to a rigid inflated state). The inflation of the toroid should be completed by the transfer of some material, gas or combination of gasses by an inflation means from a volume outside of the system to the un-inflated toroid of the aerodynamic body (preferably delivered from a pressure vessel). These details are not shown as inflating a flexible toroid is within the skill of those expert in the art. If an embodiment is used for human reentry, all or part of the toroid could be pressurized with oxygen or a breathing gas mixture to serve as a source of life support breathing gas.

### Skip Entry:

Skip entry is a technique for entering an atmosphere. It is beneficial for entry systems that have a relatively low lift-to-drag ratio since these sorts of entry systems have difficulty extending their landing range and deceleration period due to their aerodynamic flight characteristics. When engaging in skip entry a space object makes one or more successive “skips” off of (or through) the atmosphere. Each successive “skip” reduces the energy of the space object relative to the celestial body whose atmosphere is being entered. The skip entry provides a space object entering an atmosphere a longer period of time and course of transit through the atmosphere. The increased period of transit increases the duration of time during which the entering object can shed energy relative to the celestial body. By increasing the duration of the atmospheric transit the energy of the space object can be released more gradually. This gradual reduction of the space object's energy is advantageous because it reduces both heating and rapid deceleration due to frictional forces that result from the space object's physical interaction with the molecules of gas and other particulates that comprise the atmosphere.

Methods of achieving skip entry require precise guidance and control of the atmospheric entry system. Without precise guidance and control the atmospheric entry system attempting to achieve skip entry could fail to sustain its intended trajectory, which could result in one of a number of problems. If the atmospheric entry system takes too shallow of an entry trajectory, or achieves too much lift upon entry, the atmospheric entry system could skip entirely out of the atmosphere, and possibly out of the celestial body's gravity well. This could result in the complete loss of the atmospheric entry system and its payload. If the atmospheric entry system takes too steep of a trajectory, or has too small a velocity, the aerodynamics of the system may not generate enough lift for the atmospheric entry system to perform skip entry. This could cause the atmospheric entry system to engage in ballistic entry which could potentially destroy the atmospheric entry system and its payload due to excessive heating, high acceleration loads, or a high velocity impact with the surface of the celestial body. A third problematic possibility is that the atmospheric entry system achieves skip entry, but does so in such a way as to have the system and payload move off of its intended trajectory and land in an unintended location. The increased transit duration is effectively an increased flight path which allows for the atmosphere entry system to select a landing location from a larger potential landing area.

The method of skip entry into an atmosphere is achieved by calculating an appropriate trajectory, then initially descending into the outermost region of the atmosphere. After the initial descent, the aerodynamic profile of the atmospheric entry system (with or without help from some other forces including thrust or drag) generates lift which causes the entry system to ascend. As the object gradually ascends the gravitational force overrides the lift force and the object begins another descent into the atmosphere. This process may be repeated more than once before the atmospheric entry system loses the velocity (or other flight characteristics) required to generate sufficient lift to make another “skip.” When the object cannot, or does not wish to, make another “skip,” the atmospheric entry system travels along a ballistic trajectory through the remainder of the atmosphere. These “skips” increase the duration of the atmospheric entry system's transit in the upper, less dense, atmosphere. The increased duration of the atmospheric transit and the lower instantaneous deceleration gives this method of atmospheric entry many advantages as compared to fully ballistic atmospheric entry.

Increased duration of flight in the upper atmosphere is desirable because this is where most of the energy of reentry is dissipated. If the total energy release is made over more time, the effect is a much gentler and less stressful reentry.

The deceleration can be made more gradually resulting in lower acceleration loads being put on the payload and atmospheric entry system as a whole. Slower deceleration results in less intense aeroheating of the atmospheric entry system. The lower velocities and increased transit duration also reduce heat buildup on the entry system and acceleration loading on the system, which in turn allows for less mass of the system being dedicated to shielding. The increased atmospheric transit time coupled with the smaller velocities that the entry system achieves during the atmospheric entry allows the entry system more time to and ease of maneuvering.

An example method could facilitate atmospheric entry into the Earth's atmosphere from low Earth orbit. The devices and methods described can be used to provide a controlled reentry into any planetary atmosphere from any trajectory. Of course the control rules for each entry would be unique and would have to be calculated according to means well known to those skilled in the art of trajectory planning and atmospheric reentry.

The International Space Station (“ISS”) orbits the earth in low Earth orbit (“LEO”) 617. The outer bound of LEO is approximately 2,000 kilometers above the surface of the earth. In this orbit the ISS is traveling at approximately 18,000 miles per hour. In the event that some cargo needs to be safely, gently, and precisely transported from the ISS to a location on the surface of the Earth an embodiment could be used to accomplish the task.

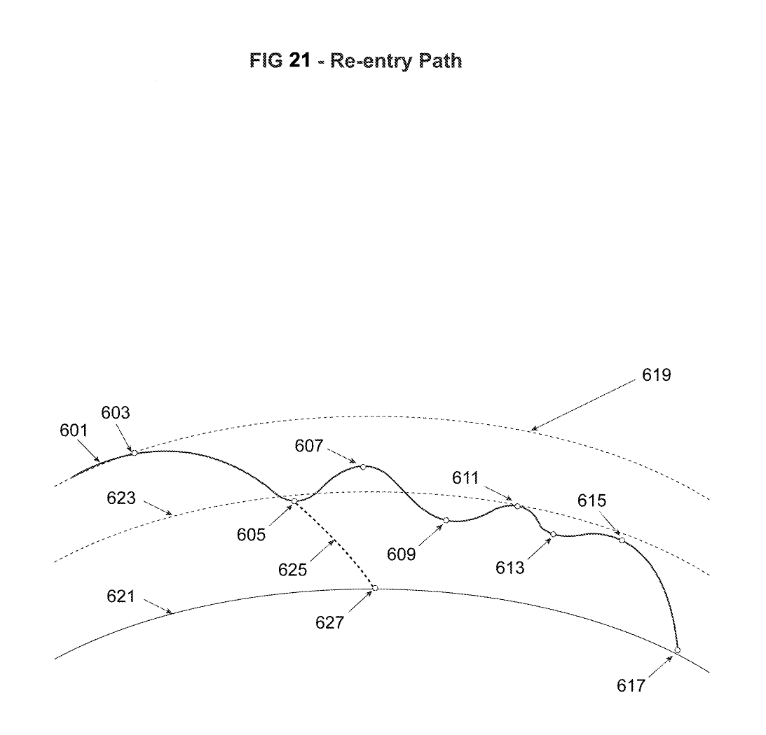

Referring now to FIG. 21, the payload would first be attached to the deflated and compact atmospheric entry system in orbit 601. Then the atmospheric entry system with the payload attached to it would be ejected from the ISS and propelled by a deorbit rocket impulse or other means into a reentry trajectory. Since the system was ejected from the ISS its orbital speed would be approximately the same as that of the ISS. As the system enters into a decaying orbit the gravitational attraction between the system and the Earth pulls the system toward the surface of the Earth with a force proportional to the square of the distance between the two objects. At some point 603 after the system is released from the ISS, but before the system begins to interact with the Earth's outer atmosphere, the inflation means pressurizes at least the toroid to rigidity. At some point after the toroid is inflated, the tether is extended through the use of a tether deployment means to a desired length.

As the system continues on a decaying orbit it begins to interact with the top layer of the atmosphere at an altitude of about 100 km 623. As the system begins to descend into the outer limits of the Earth's atmosphere the aerodynamic drag characteristics of the aerodynamic body will cause the system to orient so that said aerodynamic body shields the payload from aeroheating. At the same time the molecules of the outer atmosphere colliding with the tether generates a frictional drag force that induces a tension in the tether. The force of this tension is exerted in the opposite direction from the system's path through atmosphere. This drag force causes the system to further decelerate. If no control is exerted on the reentry system, it will follow a pure ballistic trajectory 625 and experience large thermal and structural loads before impacting on the surface at point 627.

As the tether decelerates the system the tether controller exerts forces onto the tether in such a way as to cause the tether drag force to impart a torque on the system. This torque force alters the system's aerodynamic flight characteristics, including angle of attack, generating a greater lift/drag ratio. As the lift force generated increases it will eventually offset the gravitational force between the system and the planetary surface at point 605, causing the system to gain altitude for a period of time and extend its flight distance and time through the atmosphere before the lift force is no longer greater than the gravitational force at which point the system begins to descend again at point 607. Skip entry may be used as many times as required to minimize the deceleration loads/rates on the payload, or as many times as are desired for the flight profile as is illustrated by points 609, 611, 613. With each skip the system loses energy. The control can be as simple as measuring the deceleration force and changing the angle of attack of the reentry vehicle when the deceleration exceeds some predefined limit. In theory this could yield the result of a gentle return to the surface.

The increased period of time that skip entry allows for the system to be traversing through the atmosphere allows for an increased period of time in which the tether's drag force can gently decelerate the system. Once the system's velocity, altitude, or other flight characteristic preclude the system from engaging in any further “skips” off of the atmosphere as shown at point 615 the system would begin a ballistic trajectory, although the tether and tether controller could still be used for some course modification. At this point in the system's descent should be sufficiently slow as to allow parachutes, or some other deceleration means to gently lower the system to a point on the surface of the Earth, or to simply let the system fall to the surface of the celestial body at point 617.

The flight path and controls exerted on the system can be optimized to provide for the slowest deceleration possible or controlled, constant, sustained deceleration rates. This allows for the atmospheric entries to be completed entirely within predetermined parameters (time of descent, acceleration load requirements, landing location).

In an embodiment the tether controller comprises one or more control cords attached to a point on the tether and a point on the toroid. The means of control would be by varying the tension on the one or more control cords so that the tether's drag force is deflected through the one or more control cords and exerted on the control cord's point(s) of attachment to the toroid. This action will cause the sum of the tensions on the tether and the one or more control cords to be functionally exerted on a point different than the device's center of gravity. This deflection would cause there to be a torque force impart to the device which would alter its aerodynamic flight characteristics. By changing the aerodynamic body's aerodynamic flight characteristics, including but not limited to its angle of attack, the lift to drag ratio of the system can be modified to correspond to a desired flight plan.

In certain embodiments, the tether controller comprises a control device that exerts a force on the tether such that there is a controllable change in the angle between the tether and the aerodynamic body. When the force exerted by the tether does not pass through the spacecraft's center of mass a torque alter's the spacecraft's angle of attack to change the lift forces acting on the system.

In an example embodiment the tether controller comprises a means by which the pull point of the tether may be altered in at least a two dimensions to shift the tether's force vector away from the vehicle's center of gravity to impart a moment on the vehicle to adjust pitch (angle of attack) or yaw. Furthermore, the tether's length may be extended or retracted through the use of a winch to vary the magnitude of the drag force imparted by the tether. When combined this method of controlling the length of the extended tether and the location of the pull point would allow for control of the amount of drag force that the tether would generate and where that drag force is functionally imputed on the reentry vehicle. This will provide a reactive guidance means for the atmospheric entry system as it descends through an atmosphere. If the tether is electrodynamic it may also be possible to generate drag forces outside of the atmosphere.

In certain embodiments, the tether controller comprises a means of moving the tether's physical attachment point to the rest of the system (most likely to the toroid). By moving the tether's attachment point the tether controller also moves the point at which the tether's drag force is functionally imparted to the rest of the system. If the vector along which the tether's drag force is functionally imparted to the rest of the system is moved away from the system's center of mass the drag force will impart a moment on the aerodynamic body. This moment would generally result in a change in the system's angle of attack, resulting in a change in the system's aerodynamic flight characteristics.

### Inflation:

In an example embodiment, the gas that is used to inflate the toroid to rigidity is Oxygen (O₂). In this embodiment, there would be a hose equipped with a regulator allowing controllable fluid communication between the interior of the toroid and the payload volume. In this embodiment, the O₂ used to pressurize the toroid to rigidity could be tapped into as a life support system.

In another example embodiment, the gas that is used to inflate the toroid to rigidity is Helium (He). Helium, being an inert gas, is unlikely to react with any other chemicals that it may be exposed to, and thus is unlikely to be dangerous. Helium gas is light weight which could increase the spacecraft's buoyancy. The increased buoyancy of the system could result in a smoother, gentler deceleration and stop than a less buoyant system would allow.

In an example embodiment, the toroid has a plurality of discrete compartments in fluid communication with one another through valves. The valves could be configured so that discrete compartments could be inflated by the release of pressurization material into discrete compartments, but would not allow the decompression of one compartment to deflate any other of the discrete compartments. This configuration would help the toroid retain some structural rigidity in the event of a damage that would cause depressurization.

In certain embodiments, the skin of the aerodynamic body comprises one or more compartments in fluid communication with the toroid. These compartments inflate with the same pressurization fluid as the toroid. This would aid in the prevention of communication of heat from the outer surface of the skin of the aerodynamic body to the inner surface of the skin of the aerodynamic body.

Inflatable components are light weight and can be deflated and stored in a relatively small volume.

Certain embodiments comprise an aerodynamic body, a hypersonic decelerator, and a controller that is connected to both the hypersonic decelerator and the aerodynamic body such that the forces acting on the hypersonic decelerator are transmitted to the aerodynamic body in a controllable manner so the hypersonic decelerator and control means can be used as a RCS (reaction control system) for the aerodynamic body.

In this embodiment the aerodynamic body may comprise a capsule, a shuttle, a heat shield, or an inflatable aeroshell. The aerodynamic body will preferably have flight characteristic that can be influenced by the controlled use of the hypersonic decelerator in such a way as to result in an alteration of the aerodynamic body's flight characteristics (angle of attack, lift/drag ratio, aerodynamic profile, shape, etc.).

The aerodynamic body allows the forces generated by the hypersonic decelerator to be translated from pure decelerating drag into a means for altering the flight characteristics of the system in order for the system as a whole to be controllably maneuverable.

The hypersonic decelerator refers not to a specific decelerator system but instead could comprise one, more than one, or a combination of hypersonic decelerators that rely on drag to decelerate an object traveling through an atmosphere at hypersonic speeds. This group comprises: single line tethers, multi-line tethers, tapes, ribbons, ballutes, parachutes, wings, and sails. Different hypersonic decelerators could be used simultaneously or in sequence. The hypersonic decelerator uses the drag generated by friction between the hypersonic decelerator and the atmosphere to both decelerate the entire system and to generate forces that can be controllably transferred to the aerodynamic body in order to alter the spacecraft's flight dynamics in a controllable manner.

Multiple hypersonic decelerators may be used in conjunction with one another, either having multiple distinct hypersonic decelerators used at the same time, or with different hypersonic decelerators used at different periods during the system flight in order to correspond to different deceleration requirements. This may include but is not limited to the use of different hypersonic decelerators depending on the velocity range that the system is traveling within, or the use of different hypersonic decelerators depending on the density of the atmosphere through which the system is traveling.

The control means can be any device, system, or method of use that allows for the drag forces generated by the hypersonic decelerator to be used to alter any one or more flight characteristics of the system in such a way as to allow the flight path of the system to be controlled by alteration of the drag forces acting on the hypersonic decelerator.

In a illustrative embodiment, the aerodynamic body comprises an inflatable aeroshell, the hypersonic decelerator comprises a tether, and the controller allows the spacecraft to engage in skip (single or multiple) entry of an atmosphere.

While only certain features of the selected embodiments have been illustrated and described herein, many modifications and changes will occur to those skilled in the art. It is, therefore, to be understood that the appended claims are intended to cover all such modifications and changes as fall within the true spirit of the embodiments.

What is claimed is:

1. A spacecraft reaction control system comprising:
a spacecraft having a center of mass;
a length of free tether extending from said spacecraft and offset from said spacecraft's center of mass, such that a force exerted upon said spacecraft by said free tether will be offset from said spacecraft's center of mass.

2. A spacecraft reaction control system as in claim 1, further comprising a control apparatus attached to said spacecraft and in contact with said free tether.

3. A spacecraft reaction control system as in claim 2, wherein said control apparatus determines the direction of said free tether's offset from said spacecraft's center of mass.

4. A spacecraft reaction control system as in claim 2, wherein said control apparatus determines the magnitude of said free tether's offset from said spacecraft's center of mass.

5. A spacecraft reaction control system as in claim 1, wherein said spacecraft further comprises a reel rotatably connected to said spacecraft, wherein wound tether is wound on said reel, wherein said wound tether and said free tether comprise a single length f tether.

6. A spacecraft reaction control system as in claim 5, wherein said reel comprises a a brake connected to said reel to stop or slow rotation of said reel to control unwinding of said length of tether.

7. A spacecraft reaction control system as in claim further comprising a motor connected to said reel to rotate said reel to unwind or wind said reel to change the length of said free tether and thereby affect the magnitude of a force exerted upon said free tether.

8. A spacecraft reaction control system as in claim 5, further comprising a control apparatus wherein said control apparatus comprises a center hole through which said single length of tether passes.

9. A spacecraft reaction control system as in claim 8, wherein said control apparatus further comprises a retractable arm retractably connected to said spacecraft such that said retractable arm can retract away from said spacecraft's center of mass, said retractable arm being connected to one end of a tension spring, the other end of said tension spring being connected to said center hole such that when said retractable arm retracts away from said spacecraft's center of mass, tension in said tension spring increases and causes said center hole to move in the direction of said tension.

10. A spacecraft reaction control system as in claim 8, further comprising a backup reaction control system comprising a pressurized gas propellant tank, a gas line in fluid communication with said pressurized gas propellant tank's interior, and a translation thruster in fluid communication with said gas line.

11. A spacecraft reaction control system as in claim 10, wherein said spacecraft further comprises a life support system comprising a breathable atmosphere and said pressurized gas propellant tank contains a breathable gas that that is in fluid communication with said breathable atmosphere.

12. A spacecraft reaction control system as in claim 1, wherein said spacecraft further comprises a radio communication system that is connected to said free tether so that said free tether acts as an antenna.

13. A method of controlling a spacecraft having a center of mass and having a length of free tether attached to said spacecraft comprising:
positioning said free tether's attachment to said spacecraft relative to said spacecraft's center of mass.

14. A method of controlling spacecraft as in claim 13 wherein said free tether's attachment to said spacecraft is offset from said spacecraft's center of mass so as to induce a moment that changes said spacecraft's pitch.

15. A method of controlling a spacecraft as in claim 13 wherein said free tether's attachment to said spacecraft is offset from said spacecraft's center of mass so as to induce a moment that changes said spacecraft's yaw.

16. A method of controlling a spacecraft as in claim 13 wherein said free tether's attachment to said spacecraft is offset from said spacecraft's center of mass so as to induce a moment that causes said spacecraft to roll.

17. A method of controlling a spacecraft having a center of mass and having a length of free tether attached to said spacecraft comprising:
changing the length of said free tether.

18. A method of controlling a spacecraft as in claim 17 wherein the length of said free tether is increased to thereby increase the force that said free tether exerts upon said spacecraft.

19. A method of controlling a spacecraft as in claim 17 wherein the length of said free tether is decreased to thereby decrease the force that said free tether exerts upon said spacecraft.
